(19) United States
(12) Patent Application Publication
(10) Pub. No.: US 2010/0088830 A1
(43) Pub. Date: Apr. 15, 2010

(54) DUST REMOVER FOR CONTAINER

(76) Inventor: Makoto TAKAYANAGI, Shizuoka (JP)

Correspondence Address: LEIGHTON K. CHONG;PATENT ATTORNEY, 133 KAAI STREET, HONOLULU, HI, 96821, US

(21) Appl. No.: 12/564,214

(22) Filed: Sep. 22, 2009

(30) Foreign Application Priority Data
Oct. 15, 2008 (JP) 2008-265814

(51) Int. Cl. B08B 6/00; B67C 7/00

(52) U.S. Cl. 15/1.51; 15/304; 141/92

(57) ABSTRACT

A dust remover for container comprises a holder for holding a plurality of cup-like containers in a stacked state, and air blower for blowing air to the containers in the direction perpendicular to the axis of stacked containers. Furthermore, it is preferable that the air blown from the air blowing means includes ions.

### TECHNICAL FIELD

This invention relates to a dust remover for container for removing foreign materials such as dust attached to a cup-like container.

### BACKGROUND OF INVENTION

Conventionally it is considered to be impossible that foreign materials such as dust are removed from the insides of a plurality of cup-like containers stacked in a tower state. However, in case that removal of foreign materials is indispensable, the removal of foreign materials is carried out as shown in FIG. 2. That is, the cup-like or cup-shaped container 10 is taken out from the bottommost, one at a time, the removal of foreign materials from the container 10 thus taken out is carried out in the process of air blowing by the air blower 12 or in the process of combination of air blowing and suction, and thereafter contents filling process is carried out as shown by numeral 14.

However, in the conventional dust remover, since the process of removing is carried out one container by one container, it takes long process time and long labor hour, that is, large labor charge, and since many amount of air is consumed, energy is wasted.

Therefore, it is an object of the present invention to provide a dust remover for container which can remove foreign materials from the insides of cup-like containers in a stacked state.

### SUMMARY OF INVENTION

To accomplish the object, there is provided a dust remover for container which comprises means of holding a plurality of cup-like containers in a stacked state, and means of air blowing said containers in the direction perpendicular to the axis of stacked containers. Furthermore, it is preferable that the air blown from said air blowing means includes ions.

Other objects, features, and advantages of the present invention will be explained in the following detailed description of the invention having reference to the appended drawings:

### BRIEF DESCRIPTION OF DRAWINGS

FIG. 1 is a view showing a dust remover for container according to the present invention, FIG. 1A is its plan view, FIG. 1B is its side view, FIG. 1C is a cross-sectional view along the lines of A-A of FIG. 1A, and FIG. 1D is an enlarged view of main portion for explaining about the principle, and

FIG. 2 is a view for explaining about a conventional process of removing dust.

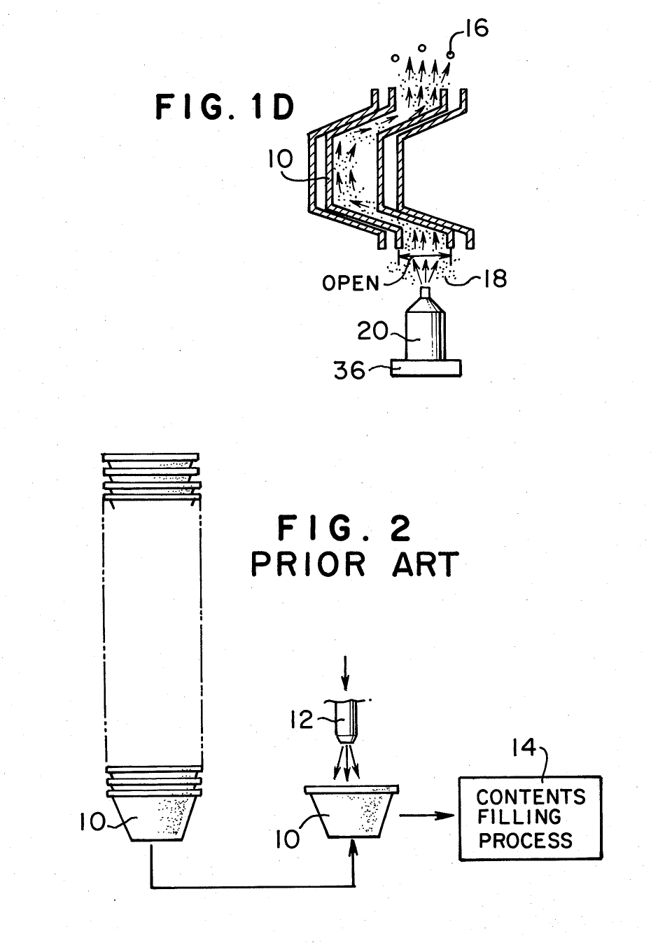

### DETAILED DESCRIPTION OF THE INVENTION

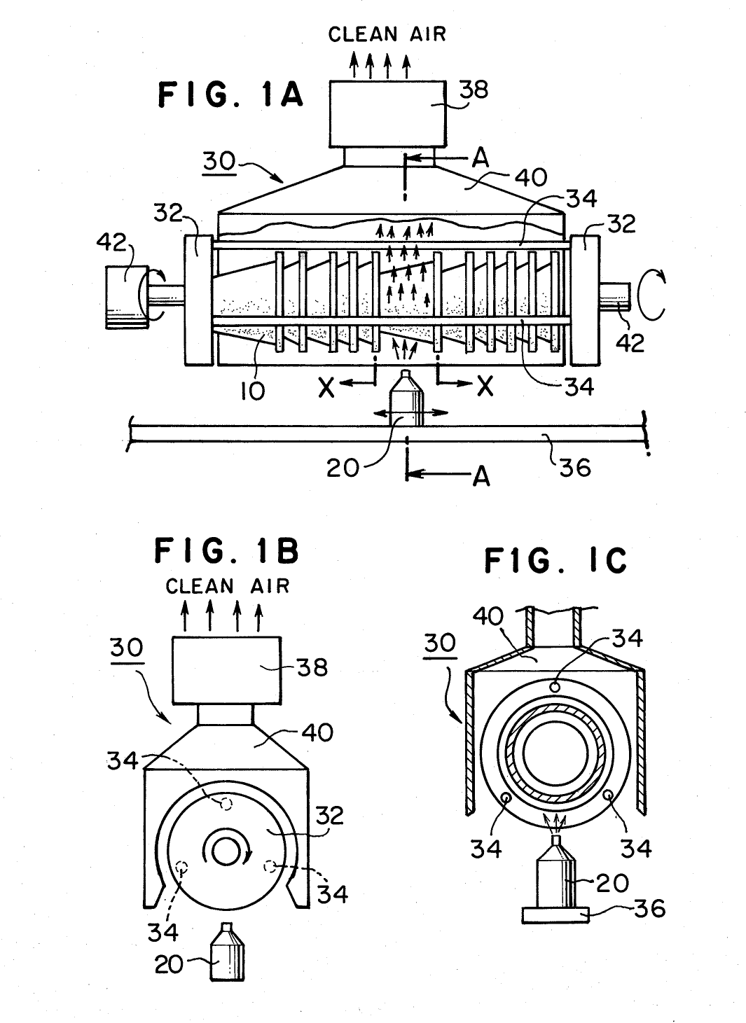

Now referring to FIG. 1, FIG. 1 is a view showing a dust remover for container according to the present invention, FIG. 1A is its plan view, FIG. 1B is its side view, FIG. 1C is a cross-sectional view along the lines of A-A of FIG. 1A, and FIG. 1D is an enlarged view of main portion for explaining about the principle.

In the embodiment, cup-like containers 10, hereinafter referred to as containers, stacked in a horizontal direction are set in a fixture 30 loosely or with a margin in a longitudinal direction. The fixture 30 includes two end bearing plates 32 and three guide poles 34, and particularly affords in a longitudinal direction. The fixture 30 is caused to rotate about its axis. Air blowing to containers 10 is carried out in the direction perpendicular to the axis of the fixture. As a result, the containers thus air blown receive wind, and as shown by arrows X and X of FIG. 1A the distance between containers 10 is enlarged. Since the distance between the containers is enlarged, the wind generated by air blowing sweeps between the containers. At that time, the foreign materials 16 such as dust in the inside of the container are blown off. Furthermore, it is preferred that ion generator, not shown, for generating ions to be contained in the air may be used. When ions are contained in the wind generated by air blowing, since electricity of the electrostatically-charged containers and foreign materials is neutralized, foreign material removal is enhanced.

Since a head 20 for air blow scans in the direction of axis of fixture and the object, that is, the container is caused to rotate about the axis by rotation drive 42, the removal of the foreign materials can be carried out for all containers. The fixture 30 for holding containers 10 comprises, for example, guide poles 34, and has a large opening not to interfere with lateral air blowing or collection of dust.

The foreign materials such as dust blown away by air blow are collected by dust collecting hood 40 and then collected by dust collector 38 and finally only clean air is discharged outside.

It is understood that many modifications and variations may be devised given the above description of the principles of the invention. It is intended that all such modifications and variations be considered as within the spirit and scope of this invention, as it is defined in the following claims.

1. A dust remover for container which comprises
means of holding a plurality of cup-like containers in a stacked state, and
means of air blowing said containers in the direction perpendicular to the axis of stacked containers

2. A dust remover for containers according to claim 1 in which ions are contained in the air blow generated by said air blowing means.

3. A dust remover for containers according to claim 1 in which said containers are stacked loosely in the direction of axis.

4. A dust remover for containers according to claim 1 in which the dust remover includes a rotation drive for rotating containers about the axis of stacked containers.

5. A dust remover for containers according to claim 1 in which the dust remover includes mean of supporting the stacked containers with the large distance.

6. A dust remover for containers according to claim 1 in which said air blowing means moves in the direction of the axis to scan the stacked containers.

7. A dust remover for containers according to claim 1 in which the dust remover includes a dust collector for collecting the dust blown out.
